(19) United States
(12) Patent Application Publication
(10) Pub. No.: US 2024/0165845 A1
(43) Pub. Date: May 23, 2024

(54) LUBRICATION SYSTEM FOR OUTDOOR TOOL

(71) Applicant: Milwaukee Electric Tool Corporation, Brookfield, WI (US)

(72) Inventors: Jonathan Paul, Brookfield, WI (US); Beth Cholst, Wauwatosa, WI (US); Hans Banholzer, Brookfield, WI (US); Casey Garces, Brookfield, WI (US); Shane McCue, Brookfield, WI (US); Peter Davies, Brookfield, WI (US); Aidan Cole, Brookfield, WI (US); Ian Hogenkamp, Brookfield, WI (US); Dylan Konop, Brookfield, WI (US)

(21) Appl. No.: 18/514,496

(22) Filed: Nov. 20, 2023

Related U.S. Application Data
(60) Provisional application No. 63/426,875, filed on Nov. 21, 2022.

(51) Int. Cl. B27B 17/12; B27B 17/02; F16N 7/38

(52) U.S. Cl. CPC B27B 17/12; B27B 17/02; F16N 7/385

(57) ABSTRACT

An outdoor tool and a lubrication system for an outdoor tool are provided. The lubrication system includes a reservoir, a pump, and an output configured to deliver lubricant to a tool unit of the outdoor tool. The pump is adjustable between a plurality of flow rate settings. The lubrication system may include one or more anti-leak mechanisms. The lubrication system may include a dedicated pump motor distinct from a motor assembly of the tool. A display system to display operating parameters of the lubrication system may be included.

### CROSS-REFERENCE TO RELATED APPLICATIONS

The present application claims priority to U.S. Provisional Patent Application No. 63/426,875 filed on Nov. 21, 2022, the disclosure of which is incorporated by reference herein in its entirety.

### FIELD

The present disclosure relates generally to lubrication systems for outdoor power tools, e.g., chain saws, pole saws and the like.

### BACKGROUND

Outdoor tools, such as pole saws and handheld chainsaws, are used to perform outdoor tasks such as cutting tree branches and other vegetation. Pole saws and chainsaws cut through material using chains with cutting teeth. The chain is typically disposed in a track on a guide bar. The chain moves relative to the track, advancing the cutting teeth along the material being cut.

Frictional resistance between the chain and guide bar decreases saw efficiency. That is, the additional resistance between the chain and guide bar results in decreased energy capacity and fewer cuts which can be made between charging or refueling. To solve this problem, lubrication may be introduced between the chain and guide bar. However, too much lubrication can attract debris, interfere with electronic components of the tool, create a worse user experience, or even cause dripping.

Accordingly, improved outdoor tool oiling systems are desired in the art. In particular, lubrication systems which offer adjustable lubrication would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a lubrication pump is provided. The pump includes a housing having an inlet, an outlet and a reservoir extending between the inlet and the outlet. The pump includes a piston disposed within the housing. The piston has a cut-out section at one end configured to be disposed within the reservoir of the housing and an inclined surface at an opposite end of the piston relative to the reservoir. The pump includes a bias spring configured to bias the piston in a first direction, and a gear configured to operably couple with a drive gear to drive movement of the piston. The pump further includes a lubricant flow adjustment system. The flow adjustment system includes an adjuster body configured to contact the inclined surface of the piston, a pin extending from the adjuster body at one end thereof, and a detent spring at an opposite end of the adjuster body from the pin and configured to bias the adjuster body in a second direction. The housing has an adjustment section comprising an adjuster housing in which the adjuster body is disposed and plurality of detent pockets disposed at a top surface of the adjuster housing, each detent pocket having a different height. The pin is configured to be exposed from the top of the adjuster housing and seated within one of the detent pockets. A position of the detent pin is configured to control an amount of reciprocating movement of the piston in the first direction to controllably adjust an amount of lubricant dispensed through the pump over a range of about 17 mL/min.

In accordance with another embodiment, a lubrication system is provided. The lubrication system includes a reservoir, a pump, and an anti-leak mechanism. The lubrication system is configured to transport a lubricant from the reservoir to an output configured to supply the lubricant to a tool unit of the power tool, The anti-leak mechanism is a separate component from the pump and the output. The anti-leak mechanism is disposed upstream of the output. The anti-leak mechanism may include one or more of a shutoff valve, a reservoir check valve and a hose manipulation mechanism.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a cross-sectional view of an outdoor tool in accordance with embodiments of the present disclosure;

FIG. 2 is a perspective view of a lubricant pump in accordance with embodiments of the present disclosure;

FIG. 3A is a side view of the lubricant pump of FIG. 2 at a high flow setting, with the housing of the pump shown in translucence;

FIG. 3B is a side view of the lubricant pump of FIG. 2 at a lowest flow setting, with the housing of the pump shown in translucence;

FIG. 4 is a perspective view of a lubricant pump in accordance with embodiments of the present disclosure;

FIG. 5 is a perspective view of a lubricant pump in accordance with embodiments of the present disclosure, with the housing of the pump shown in translucence;

FIG. 6A is a perspective view of a shutoff valve in a closed position in accordance with embodiments of the present disclosure, with the housing of the pump shown in translucence;

FIG. 6B is a perspective view of the shutoff valve of FIG. 6A in an open position, with the housing of the pump shown in translucence;

FIG. 6C is a side cross-sectional view of a shutoff valve in a closed position in accordance with embodiments of the present disclosure;

FIG. 6D is a side cross-sectional view of a shutoff valve in a closed position in accordance with embodiments of the present disclosure;

FIG. 7 is a side view of a shutoff valve indirectly actuated by a trigger in accordance with embodiments of the present disclosure;

FIGS. 8A-B illustrate a schematic view of an embodiment of a hose manipulation mechanism in accordance with embodiments of the present disclosure;

FIGS. 9A-B illustrate a schematic view of an embodiment of a hose manipulation mechanism in accordance with embodiments of the present disclosure;

FIGS. 10A-B illustrate a schematic view of an embodiment of a hose manipulation mechanism in accordance with embodiments of the present disclosure;

FIG. 11 illustrates a graph of temperature and pressure over time based on cracking pressure of a reservoir of oil lubrication systems in accordance with embodiments of the present disclosure;

FIG. 12 illustrates a schematic representation of operation of a lubrication system in accordance with embodiments of the present disclosure; and

FIG. 13 illustrates a display system in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including.” “has.” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, tools described herein can utilize lubrication systems which more precisely dispense lubricant during operation of the tool, e.g., by controllably adjusting a flow rate of a lubricant pump. The pump includes a piston and an adjuster coupled with a pump housing that is configured to control a range of motion of the piston to thereby control the flow rate through the pump. The adjuster and pump may have a plurality of detent positions that a pin of the adjuster may be inserted in to adjust the flow. For instance, there may be seven or more detents. The pump flow rate may be adjusted over a range of 17 mL/min or more, e.g., from about 3 mL/min to about 20 mL/min. The lubrication system may include one or more anti-leak mechanisms including but not limited to one or more shutoff mechanisms, including but not limited to a valve and/or a hose manipulation mechanism. A dedicated pump motor may be provided to operate the pump distinct from a motor assembly of the tool. A display system may display one or more parameters of the lubrication system to a user. The lubrication systems described herein can allow for sufficient lubrication of the tool while preventing excessive lubrication or leakage which may occur in traditional tools. Utilizing systems and methods described herein can therefore increase operational lifespan of the tool while decreasing leakage caused by excessive lubricant which may occur while the tool is inactive, stored, or otherwise not in use.

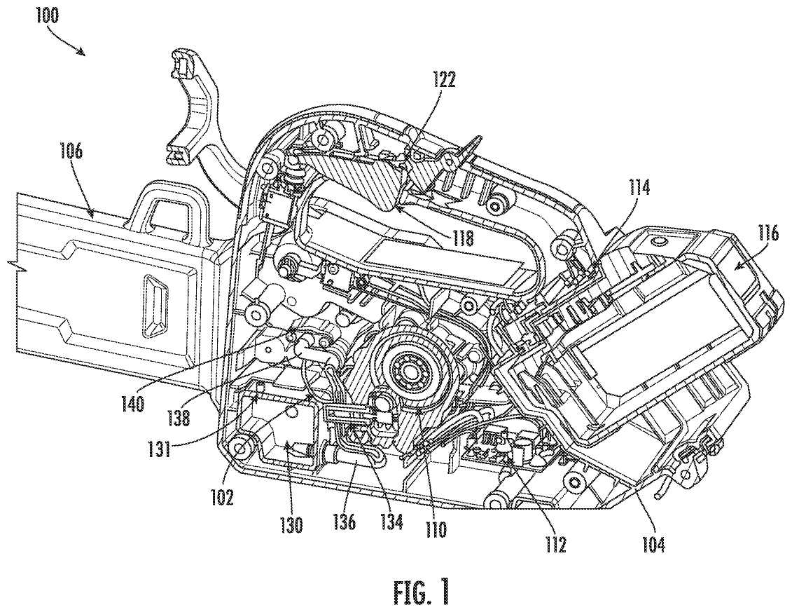

Referring now to the drawings, FIG. 1 illustrates a cross-sectional view of a tool 100 in accordance with exemplary embodiments of the present disclosure. In particular, the tool 100 shown in FIG. 1 is a chain saw. The tool 100 has a lubrication system 102 disposed within a housing 104 of the tool 100. The tool 100 can further include a guide bar assembly 106 including a guide bar that receives a chain (not shown), e.g., circumscribed around the guide bar, a motor assembly 110 within the housing 104, a control assembly 112, a battery receiver 114, a battery 116 to power the tool 100, or any combination thereof.

A user interface, e.g., a trigger 118, can be disposed at a location whereby an operator can control operation of the tool 100. The trigger 118 can control the motor assembly 110 of the tool 100 to drive the chain along the guide bar. By way of non-limiting example, the motor assembly 110 can include a motor having an output shaft. The output shaft can be in communication with the chain, e.g., through a transmission having a drive gear, so as to move the chain along the guide bar. For instance, the drive gear may be rotatably coupled to the transmission, and the chain may be in operable communication with the drive gear (e.g., the chain may circumscribe a portion of the drive gear) such that the drive gear can drive the chain about the guide bar. A sensor 122 can detect the relative position of the trigger 118. When the trigger 118 is activated, e.g., depressed, the speed of the motor assembly 110 can increase. Conversely, when the trigger 118 is deactivated, e.g., not depressed, the motor assembly 110 can stop. In certain instances, the motor assembly 110 can be a variable speed motor and a relative activated position of the trigger 118 can inform the speed of the variable speed motor. That is, the operator can control the speed of the chain along the guide bar based on how far the trigger 118 is depressed. A secondary user interface, e.g., a power button (not shown), can be used to control another aspect of the tool 100. The power button can include, for example, a toggle which can be moved between ON and OFF positions. The tool 100 may not function when the power button is in the OFF position.

Still referring to FIG. 1, the lubrication system 102 will now be described in further detail. The lubrication system 102 includes a lubricant reservoir 130 configured to house a lubricant 132. The lubricant reservoir 130 is fluidly coupled to a pump 134 via a first hose 136, also referred to as a hose or a first hose. Downstream of the pump 134, a second hose 138 fluidly couples the pump 134 to an output 140 configured to dispense the lubricant adjacent to the chain so as to lubricate the chain. The pump 134 can draw lubricant 132 from the reservoir 130 via the hose 136 and deliver lubricant through the second fluid conduit 1348 to provide the lubricant at a location adjacent to the chain.

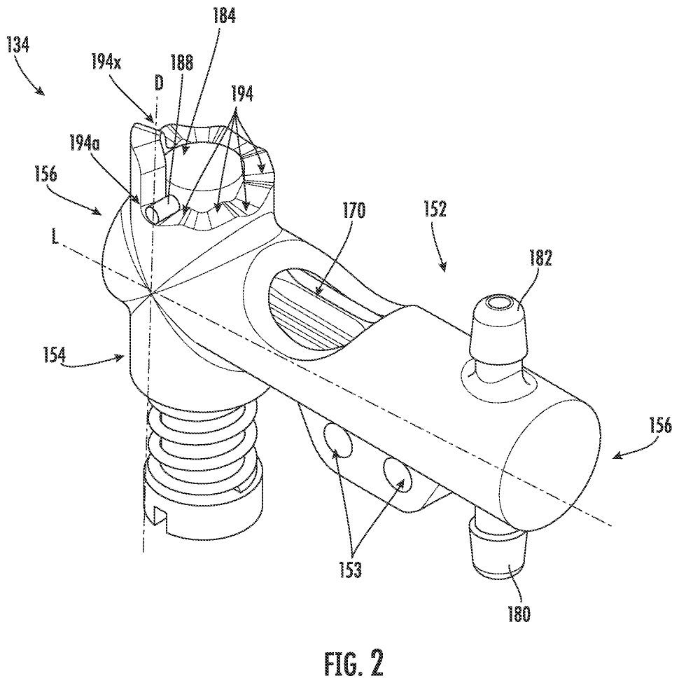

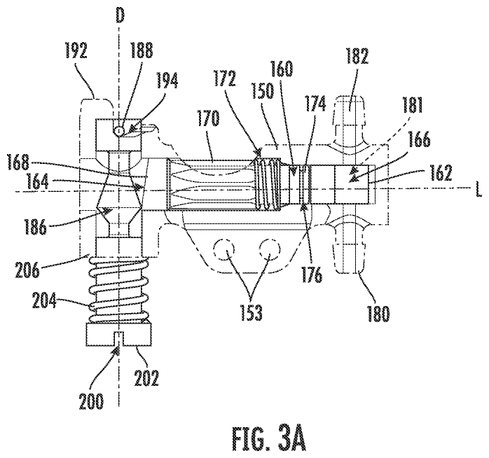

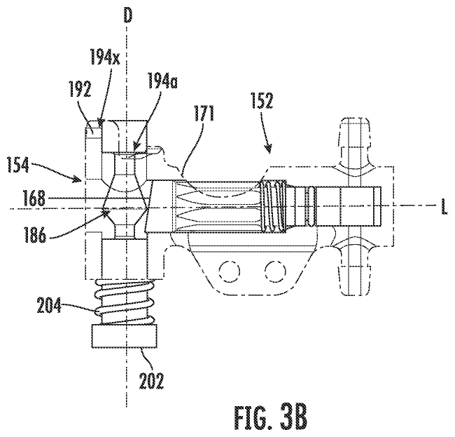

FIGS. 2 and 3A-3B illustrate an embodiment of the pump 134 according to the present invention. The pump 134 includes a housing 150 having a first portion 152 extending along a longitudinal direction L and a second portion 154 extending in a second direction D. The second direction D may be generally perpendicular to the longitudinal direction L. The first portion 152 may extend from a first end 156 to a second end 158 along the longitudinal direction L. The second portion 154 may be disposed at the second end 158. In some aspects of the invention, the first portion 152 may have a generally cylindrical shape and the second portion 154 may have a generally cylindrical shape. One or more mounting holes 153 may be provided on the housing 150, e.g., extending from the generally cylindrical shape of the first portion 152.

The pump 134 includes a lubricant inlet 180 and a lubricant outlet 182 disposed generally near to the first end 156 and/or spaced apart from the second portion 154. The lubricant inlet 180 may be coupled with the fluid hose 136 or first hose to draw lubricant into the pump 134 from the reservoir 130, and the lubricant outlet 182 may be coupled with the fluid hose 138 or second hose to pump lubricant to the output 140. A chamber 181 is disposed between the lubricant inlet 180 and the lubricant outlet 182 for the lubricant to pass therethrough.

The pump 134 includes a piston 160 extending within the first portion 152 (as best seen in FIG. 3A-3B). The piston 160 has a first end 162 and a second end 164. At the first end 162, the piston includes a cut-out portion 166, e.g., a flat or rounded cut-out face extending inward along the longitudinal direction L from the first end 162. The cut-out portion 166 may be configured to be disposed between the lubricant inlet 180 and the lubricant outlet 182. At the second end, the piston 160 has an inclined surface 168 forming a cam surface.

The piston 160 further includes a gear 170 configured to operably couple with a drive gear to cause reciprocal movement of the piston 160 along the longitudinal direction L. The gear 170 may extend about a circumference of the piston 160. A spring 172 may be positioned about the piston 160. For instance, the spring 172 may surround a portion of the piston 160. The spring 172 may be configured to bias the piston 160 toward the first end 156 or second end 158 of the housing 150. For instance, as illustrated in FIGS. 3A-3B, the spring 172 may bias the piston 160 toward the second end 158.

The piston 160 may further include at least one seal 174. For instance, the piston 160 can include a channel 176 surrounding a circumference of the piston 160 disposed between the cut-out portion 166 and the second end 164 and the seal 174 may be disposed within the channel 176. The seal 174 can be an O-ring or any other suitable seal to prevent lubricant from spreading between the seal 174 and the second end 164.

The pump 134 further includes a lubricant flow adjustment system. The lubricant flow adjustment system may be configured to adjust a flowrate of the pump 134 in a range from about 3 mL/min to about 20 mL/min, i.e., over a range spanning about 17 mL/min. The present inventors have found that the lubricant flow adjustment system of the present invention may provide a superior range of flowrates as compared to existing outdoor power tool lubricant flowrate adjusters.

The lubricant flow adjustment system includes an adjuster 184 operably coupled with the second portion 154 of the pump housing 150. The adjuster 184 can extend along the second direction D and extend within the second portion 154 of the housing 150. The adjuster 184 includes a pointed section 186 configured to be in operable contact with the inclined surface 168 of the piston 160. At least a portion of the adjuster 184 including a pin 188 is configured to extend outward from an opening 190 of the second portion 154 of the pump housing 150. At an opposite end of the adjuster 184 from the pin 188, the adjuster 184 may include a slot 200 on a bottom surface 202 of the adjuster 184. The slot 200 may be a minus slot (i.e., forming a straight line similar to a minus symbol ‘-’ across a lower surface of the adjuster 184), or any other suitable shape of a slot or keyed opening in the lower surface of the adjuster 184. An adjuster spring 204 may be positioned about the adjuster 184, e.g., between the bottom surface 202 and a lower surface 206 of the second portion 154 of the pump housing 150 to bias the adjuster 184 downward along the second direction D. The slot 200 may be operably coupled with a controlling mechanism (not shown) that may be configured to engage the slot 200 and rotate the adjuster 184 to a rotational position corresponding to a desired one of the detents 194 for an intended lubricant flow rate.

The lubricant flow adjustment system of the present invention including the adjuster 184 may have a retention force of about 2 in-lb torque or more, e.g., over 2 in-lb torque. The present inventors have found that increasing the retention force of the lubricant flow adjustment system of the present invention, as compared to existing outdoor power tool lubricant adjusters, enables more accurate adjustment of the flowrate by preventing the adjuster 184 from being inadvertently rotated (and thereby inadvertently changing the flowrate).

The second portion 154 has a top surface 192 thereof surrounding the opening 190. The top surface 192 includes a plurality of detents 194 of different height in the direction D. The pin 188 is configured to extend from the adjuster 184 in a direction generally perpendicular to the second direction D such that the pin 188 may rest on or be seated within one of the detents 194. As best seen in FIG. 2, the top surface 192 includes a plurality of detents 194, such as at least four detents, at least six detents, at least eight detents, or more, each extending at a different height along the direction D. In one particular embodiment, there may be seven detents 194. The detents 194 may increase in height from a first detent 194a to an ultimate detent 194x. The detents 194 may increase in height about a circumference of the second portion 154 of the housing 150. For instance, in some aspects the detents 194 may extend about a full 360-degree circumference of the second portion 154, or the detents 194 may extend about only a portion of a circumference of the second portion 154. For example, as illustrated in FIG. 2, the detents 194 may extend about an angle of 270 degrees of the circumference of the second portion 154.

A height of each respective one of the detents 194 may correspond to an amount of reciprocal movement of the piston 160 along the direction L by varying the point of contact between the pointed section 186 of the adjuster 184 and the inclined surface 168 of the piston 160. As the pin 188 is moved to a detent 194 of increased height, e.g., as illustrated in FIG. 3B, the pointed section 186 increases in height along the direction D, thereby reducing the reciprocal range of motion of the piston 160 due to the point of contact between the pointed section 186 and the inclined surface 168 of the piston 160. When the reciprocal range of motion of the piston 160 in the longitudinal direction L is decreased, less lubricant may pass through the pump 134 from the inlet 180 to the outlet 182 due to reduced range of motion of the cut-out portion 166 between the inlet 180 and the outlet 182. In contrast, when the pin 188 is disposed at the lowest detent 194a, e.g., as shown in FIGS. 2 and 3A, the pump 134 may operate at a maximum lubricant flow rate by enabling a maximum reciprocal range of motion of the piston 160.

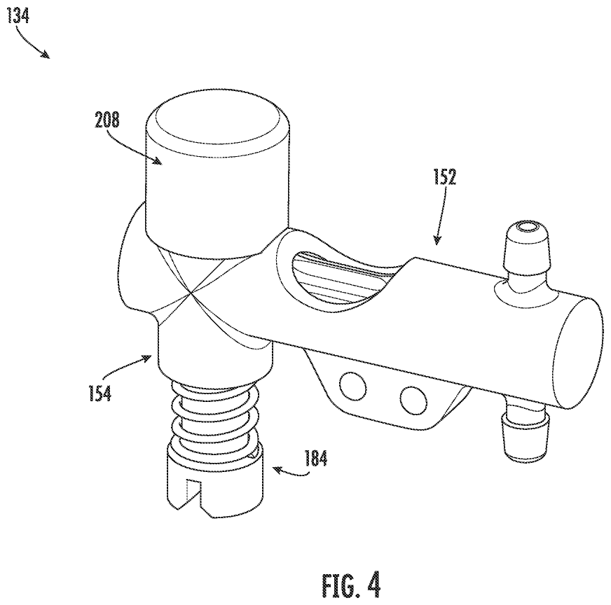

In some aspects of the invention, a cap 208 may be provided to cover the upper end of the adjuster 184 and the second portion 154 of the housing 150. For instance, the cap 208 may act as a grease cap to retain any grease or lubricant on the top surface 192 of the second portion 154 and/or the adjuster 184. In some aspects, the cap 208 may have a generally cylindrical shape as shown in FIG. 4. However, any suitably shaped cap 208 for retaining grease or lubricant and prevent the grease or lubricant from exiting the housing 150.

FIGS. 2 and 3A-B illustrate a pump 134 having a mid-gear style piston 160. In other words, the piston 160 has a gear 170 that is generally disposed at a mid-portion of the piston 160. As shown in FIGS. 2 and 3A-B, the housing 150, for instance, the first portion 152 of the housing 150, includes an opening 171 configured to expose the gear 170. In this arrangement, the gear 170 is disposed along the piston 160 at a position between the inclined surface 168 at the second end 164 and the cut-out portion 166 at the first end 162. However, the present invention contemplates any suitable style of piston gear assembly.

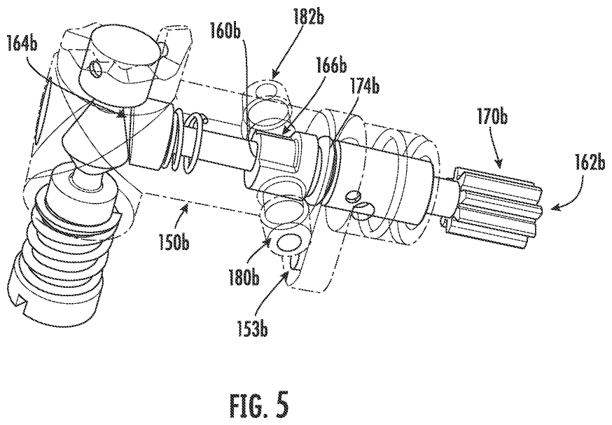

For instance, FIG. 5 illustrates a plug-gear style piston 160b having a gear 170b that extends outward along the longitudinal direction L from the housing 150b of the pump 134. Same reference numbers are used to denote parts of the housing 150b and piston 160b as used to describe the housing 150 and piston 160 of FIGS. 2-4. The gear 170b is disposed at the first end 162b of the piston 160b, and the cut-out portion 166b is disposed along the piston 160b between the first end 162b and the second end 164b. The cut-out portion 166b may be formed as a semi-cylindrical cut-out as shown in FIG. 5, or a flat cut-out portion similar to that shown in FIGS. 2-4, or any other suitable cut-out shape to enable lubricant to pass therethrough from the lubricant inlet 180b to the lubricant outlet 182. The seal 174b may be disposed between the cut-out portion 166b and the first end 162b to prevent lubricant from leaking out of the housing 150 where the piston 160b protrudes from the housing 150b. Optionally, as illustrated in FIG. 5, the lubricant inlet 180b, lubricant outlet 182b and/or the mounting holes 153b may have a different orientation relative to the first portion 152b of the housing 150b as compared to those of the embodiment illustrated in FIGS. 2-4. However, the lubricant inlet 180b, lubricant outlet 182b and mounting holes 153b may have any suitable arrangement and/or orientation as desired to suitably be arranged within the housing 104 of the tool 100.

The lubrication system 102 of the present invention may have one or more lubricant flow shutoff mechanisms disposed along the lubricant flow path at a point upstream of the output 140. For instance, the lubrication system 102 may include one or more lubricant shutoff valves 210. The lubricant shutoff valve 210 may be coupled with the lubricant inlet 180 or lubricant outlet 182 of the pump 134 (i.e., between the pump 134 and either the first hose 136 or second hose 138), or at any other suitable location upstream of the output 140. For instance, the lubricant shutoff valve 210 may be disposed between the reservoir 130 and the first hose 136, at a downstream end of the second hose 138 upstream of the output 140, or at any point along the first hose 136 or second hose 138. By providing the valve 210 upstream of the output 140, the lubrication system 102 can be closed or sealed off to prevent any leaking or spillage of lubricant 132 when the tool 100 is not in operation.

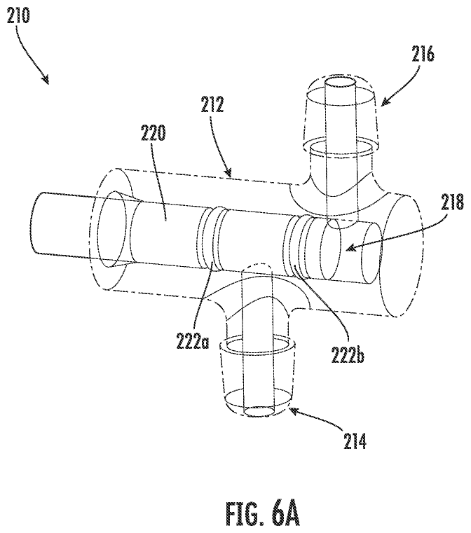

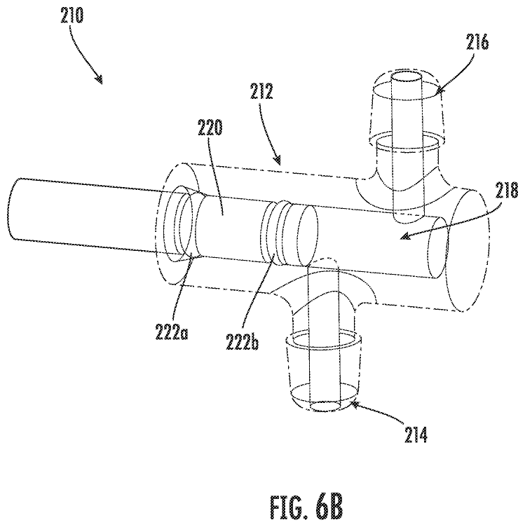

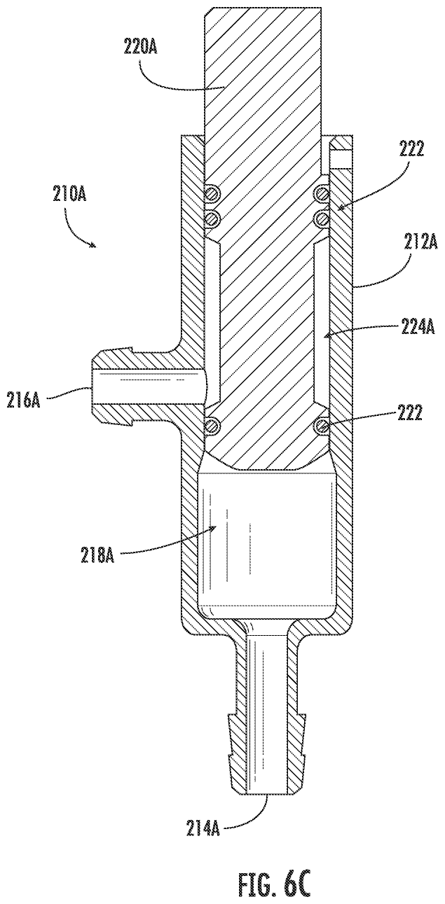

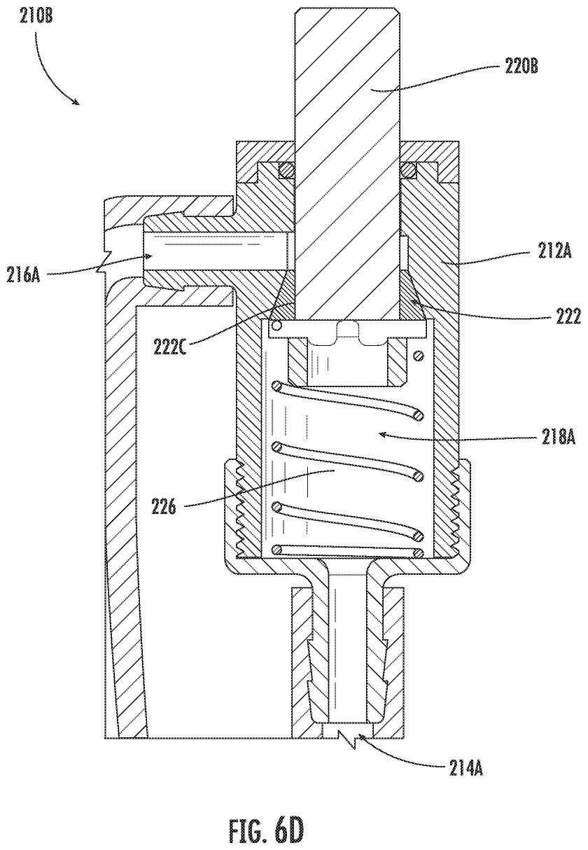

FIGS. 6A-D illustrate examples of a shutoff valve 210 contemplated by the present invention.

FIG. 6A shows a shutoff valve 210 in a closed position, and FIG. 6B shows a shutoff valve 210 in an open position. The valve 210 has a body 212 with an inlet 214 and an outlet 216. A chamber 218 is disposed between the inlet 214 and the outlet 216 such that, in the open position, lubricant 132 can flow from the inlet 214 and the outlet 216. Although FIGS. 6A-B illustrate the inlet 214 and outlet 216 as non-aligned in a longitudinal direction of the valve 210, the present invention further contemplates any embodiment in which the inlet 214 and outlet 216 may be linearly aligned. The valve 210 includes a stem 220 configured to be seated within the chamber 218. For instance, the stem 220 can extend linearly through the chamber 218 and may be movable in the longitudinal direction within the chamber 218 between the closed (FIG. 6A) and open (FIG. 6B) positions of the valve 210. In the closed position, shown in FIG. 6A, the stem 220 is configured to prevent flow of lubricant between the inlet 214 and the outlet 216.

In some aspects, the stem 220 of the shutoff valve 210 may include one or more seals 222, e.g., a first seal 222a and a second seal 222b. The seal(s) 222 may prevent flow of lubricant past the stem 220 in a direction opposite the flow of lubricant 132 from the inlet 214 to the outlet 216. For instance, in the arrangement illustrated in FIGS. 6A-B, the first seal 222a is configured to seal the stem 220 to prevent lubricant flowing from the inlet 214 from exiting the body 212 of the valve 210 where the stem 220 protrudes from the body 212. The second seal 222b can be disposed downstream of the inlet 214 when the valve is in the closed position (FIG. 6A), thereby preventing lubricant from leaking from the inlet 214 to the outlet 216 through the chamber 218. When the valve 210 is in the open position as shown in FIG. 6B, the second seal 222b further seals lubricant from flowing from the inlet 214 from exiting the body 212 of the valve 210 where the stem 220 protrudes from the body 212 without preventing flow from the inlet 214 to the outlet 216.

FIGS. 6C and 6D illustrate further aspects of a shutoff valve, e.g., shutoff valves 210A and 210B. For instance, in some aspects of the present invention, the inlet 214A and outlet 216A of a shutoff valve may be coupled to a housing 212A and oriented at an angle relative to each other, as shown in FIGS. 6C and 6D. For instance, the inlet 214A and outlet 216A may be oriented at an angle greater than 0° and less than 180°, e.g., in a range from about 30° to about 150°, such as from about 60° to about 120°. In some aspects, an angle between the inlet 214A and the outlet 216A may be between about 80° and about 100°, i.e., approximating a right or 90° angle.

For instance, as shown in FIGS. 6C and 6D, in some aspects, the inlet 214A and the valve stem 220A, 220B may extend generally along a common longitudinal axis. When the valve 210A, 210B is in an open position (not shown), the valve stem 220A, 220B may be pushed in a direction toward the inlet 214A and into a chamber 218, thereby releasing a seal 222. Lubricant may then flow through the inlet 214A into the chamber 218A, through the chamber 218A, and out through the outlet 216A when the valve 210A, 210B is in an open position. The chamber 218A may have a diameter wider than a diameter of the valve stem 220A, 220B, respectively, to enable lubricant to flow around the valve stem 220A, 220B through to the outlet 216A.

The shutoff valve may further include a resilient element 226 disposed in the chamber 218A. For instance, the resilient element 226 may be in the form of a coil spring, as illustrated in FIG. 6D. The resilient element 226 may bias the valve stem 220A, 220B in a direction towards the closed position. In this manner, when the valve stem 220A, 220B is not actuated towards the open position, the resilient element 226 may bias the valve stem 220A, 220B toward the closed position, thereby further preventing leakage of lubricant through the shutoff valve.

FIG. 6C illustrates an exemplary shutoff valve having O-ring seals 222 similar to the arrangement of FIGS. 6A-6B. For instance, a plurality of O-ring seals 222 may be provided along the stem 220A. In the arrangement illustrated in FIG. 6C, at least one O-ring seal 222 may be provided along the valve stem 220A on either side of the outlet 216A when the valve is the closed (FIG. 6C) or open (not shown) position. By providing seals 222 on both sides of the outlet 216A, lubricant may be prevented from leaking out from the housing 212A along the valve stem 220A.

FIG. 6D illustrates an exemplary shutoff valve having a seal 222 in a form of a conical seal 222C instead of an O-ring seal. However, FIGS. 6A-D are not intended to be limiting regarding the precise shape of the seal(s) provided on the valve stem 220. The present invention contemplates any combination of seals, e.g., O-ring seals, conical seals, seals having alternative cross-sectional shapes, and the like.

While the valve 210, 210A, 210B illustrated in FIGS. 6A-D illustrate various examples of a linearly operated valve, the present invention contemplates any suitable valve operation mechanism, e.g., a rotational movement of a valve stem or plug member. Additionally or alternatively, a passive check valve can be provided downstream of the pump 134 to prevent leakage of lubricant 132.

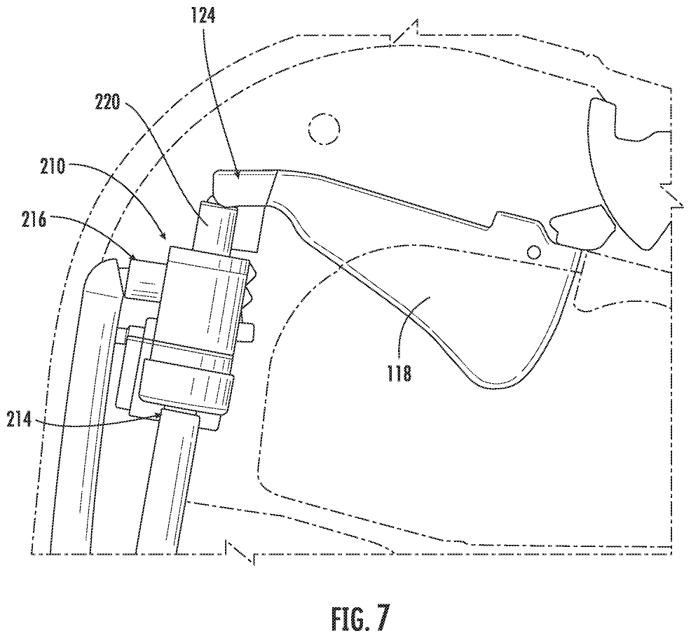

For instance, as illustrated in FIG. 7, a lubricant shutoff valve 210 may be provided downstream of the pump 134 and upstream of the output 140 at a location near the trigger 118 of the tool 100. Actuation of the trigger 118 may actuate the shutoff valve 210. For instance, the shutoff valve 210 may be indirectly actuated by the user (i.e., an indirect user interface). The user may directly actuate the trigger 118, which then actuates (or rather, deactivates, to enable lubricant flow) the shutoff valve 210. More specifically, actuation or engagement of the trigger 118 may cause a trigger output piece 124 to rotate. The trigger output piece 124 may rotate toward the valve stem 220 of the shutoff valve 210. The rotational movement of the trigger output piece 124 may cause linear actuation of the valve stem 220 of the shutoff valve 210, e.g., moving the valve stem 220 toward the chamber 218 and into the open position. While FIG. 7 illustrates a shutoff valve 210 actuated by the trigger, the present invention further contemplates a similar arrangement in which a shutoff valve is actuated or closed by a chain brake handle (not shown) of a chain saw.

However, the present invention further contemplates direct actuation of a shutoff valve 210, e.g., by providing a button, knob, or other suitable user-actuable element on a housing of the tool 100 as a direct user interface to actuate the shutoff valve 210. Moreover, the present invention contemplates that a shutoff valve 210 may be actuated electronically, e.g., by a circuit coupled to the trigger, or by firmware, e.g., through a control unit. Physical movement of a valve stem 220 of a shutoff valve 210 may be actuated by a linkage, knob, plunger, switch, magnet, or any other suitable mechanism. In some aspects of the present invention, the shutoff valve 210 may be actuated by pressure, e.g., when pressure from lubricant through the inlet 214 or in the chamber 218 exceeds a threshold.

In addition to and/or in place of a shutoff valve, the lubricant flow shutoff mechanism of the lubrication system 102 may include one or more hose manipulation mechanisms coupled with either or both of the first hose 136 and second hose 138. For instance, as shown in FIGS. 7A-B, 8A-B, and 9A-B, a hose manipulation mechanism 230 (also referred to as a hose manipulator) may be provided along the first hose 136 between the reservoir 130 and the pump 134. The hose manipulation mechanism 230 may be configured to manipulate the hose 136 to obstruct flow of lubricant 132 therethrough. Thus, the flow of lubricant 132 can be shut off and leakage of lubricant 132 can be reduced or eliminated when the tool 100 is not in operation. For instance, FIGS. 7A, 8A and 9A each illustrate a hose manipulation mechanism 230a, 230b, 230c, respectively, in an open configuration in which flow is not occluded. FIGS. 7B, 8B and 9B each illustrate the hose manipulation mechanisms 230a, 230b, 230c, respectively, in a closed or active configuration in which flow of lubricant 132 through the hose 136 is occluded.

FIGS. 7A-B schematically illustrate a hose manipulation mechanism 230a having at least one first member 232a and at least one second member 234a. In the active configuration, the hose 136 is configured to be bent or kinked between the first member 232a and the second member 234a. For instance, the second member 234a may be actuated to move in a direction toward the first member 232a, or as illustrated, two first members 232a, to bend or kink the hose 136 between the first member 232a and the second member 234a. The reservoir 130 and the pump 134 may be disposed on opposite sides of the hose manipulation mechanism 230a.

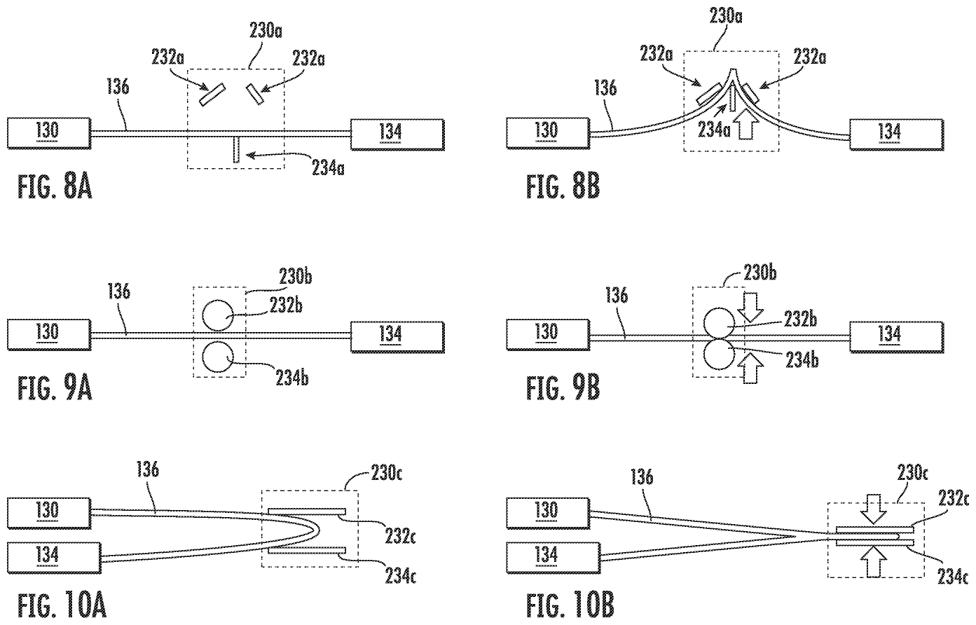

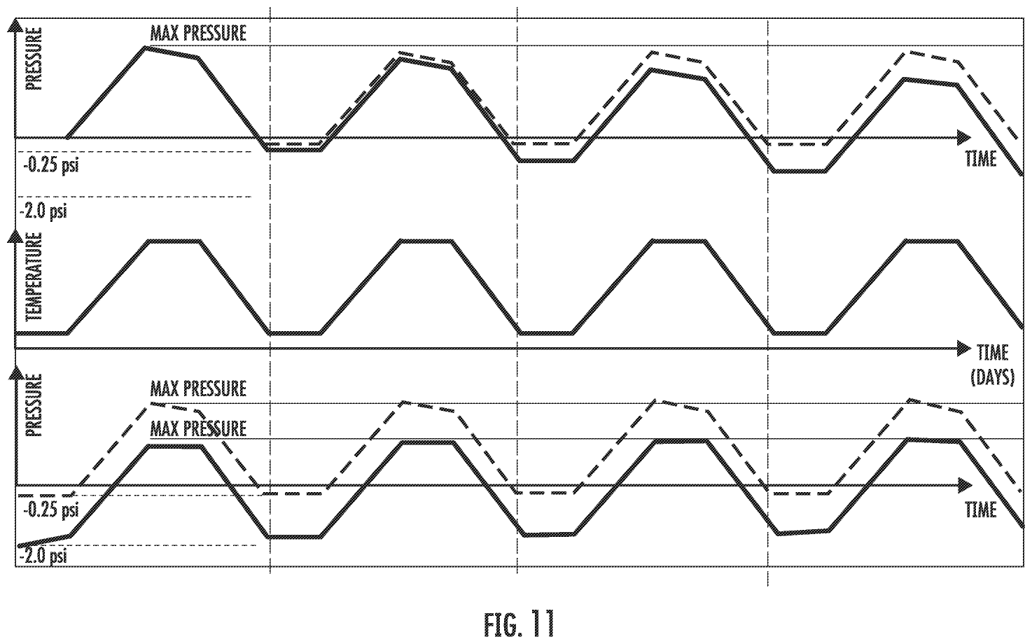

FIGS. 8A-B schematically illustrate a hose manipulation mechanism 230b having a first member 232b and a second member 234b. In the active configuration, the hose 136 is configured to be squeezed, pinched or clamped between the first member 232b and the second member 234b. For instance, the first member 232b and the second member 234b may be actuated to move in a direction toward each other to compress the hose 136. The first member 232b and the second member 234b may be in the form of rollers or any other suitable shape to squeeze or compress the hose therebetween. The reservoir 130 and the pump 134 may be disposed on opposite sides of the hose manipulation mechanism 230b.

FIGS. 9A-B schematically illustrate a hose manipulation mechanism 230c having a first member 232c and a second member 234c. In the active configuration, the hose 136 is configured to be folded between the first member 232c and the second member 234c. For instance, the first member 232c and the second member 234c may be actuated to move in a direction toward each other to fold the hose 136 therebetween. The first member 232b and the second member 234b may be in the form of plates or any other suitable shape to fold the hose therebetween. A distinction between the hose manipulation mechanism 230b and the hose manipulation mechanism 230c is that the hose 136 is wrapped or curved so that the reservoir 130 and pump 134 are on the same relative side of the hose manipulation mechanism 230c.

In addition to and/or in place of a valve 210 and/or a hose manipulation mechanism as described above, the lubrication system 102 may include a check valve 131 or other vacuum relief valve in the reservoir 130. The check valve 131 may allow ambient air to enter the oil tank to relieve a vacuum within the oil tank.

Pressure buildup within the lubrication system 102, and especially within the reservoir 130, may cause lubricant leaks in storage (i.e., when the tool is not in use). For instance, a thermal lubricant leak may occur when heated and pressurized air within the reservoir 130 pushes lubricant out of the lubrication system. More specifically, when the temperature rises, air pressure within the lubrication system and especially within the reservoir 130 rises. As the air pressure rises, the increased pressure forces lubricant through the lubrication system and may cause lubricant to leak out the outlet.

The cracking pressure of the check valve 131 determines the difference in pressure between the ambient environment and the oil reservoir 130 that is needed to allow the check valve 131 to open and allow ambient air to enter the oil tank to relieve the vacuum. The check valve 131 of the present invention may have a cracking pressure of about 1.5 pounds per square inch (psi) or greater, such as 2 psi or greater. For instance, a 1.5 psi vacuum relief check valve will only allow ambient air to enter the oil tank if the tank pressure is 1.5 psi less than the ambient air pressure. A 1.5 psi drop in pressure in the reservoir 130 may occur in the following ways: (1) when the oil pump is running during normal tool operation, drawing lubricant out of the reservoir 130 (i.e., the tool is in use); (2) the temperature inside the reservoir 130 drops by about 30 degrees Celsius; (3) the tool is moved to a location that has an ambient pressure that is 1.5 psi higher than a previous location of the tool.

The present inventors have found that a check valve 131 having a cracking pressure of greater than or equal to 1.5 psi may significantly lessen the leak rate of lubricant from the reservoir 130 when the tool is in storage, i.e., not in use. Without intending to be bound by a particular theory, this may be because a greater cracking pressure may lead to a lower overall reservoir air pressure when the tool is in storage, as a greater pressure differential is required to allow ambient air into the reservoir 130. For instance, as described above, a pressure differential of 1.5 psi may be effected by a 30 degree Celsius temperature drop within the reservoir 130, which is a large magnitude of a temperature drop relative to typical atmospheric temperatures.

FIG. 11 graphically represents relative temperature and pressure over time in a reservoir, e.g., a reservoir 30, having a check valve. Graph (b) illustrates change in temperature over time, e.g., in days. The temperature generally cyclically rises in the early part of a day, remains at a raised temperature, lowers in the later part of the day, and remains low overnight. As the temperature increases and decreases, relative pressure within the reservoir increases and decreases. In graphs (a) and (c), the solid line represents relative pressure in a reservoir having a check valve with a cracking pressure of 2.0 psi, and the dashed line represents relative pressure in a reservoir having a check valve with a cracking pressure of 0.25 psi.

As shown in graph (a), the high cracking pressure valve (solid line) reduces the average air pressure in the oil tank when the temperature changes—the average air pressure decreases over time. This occurs because ambient air is not allowed into the system to relieve the vacuum due to the relatively high cracking pressure of 2.0 psi, which would require a temperature change of greater than 30° ° C. to cause a 2.0 psi pressure differential. The reduction of overall reservoir pressure thereby can reduces leak. In contrast, when the cracking pressure is relatively low, e.g., 0.25 psi as shown by the dashed line, the check valve may open and allow ambient air into the reservoir to relieve the vacuum, and the overall reservoir pressure remains higher compared to the system with the 2.0 cracking pressure check valve.

After users run the chainsaw, the reservoir air pressure relative to ambient will likely be around the negative magnitude of the valve's cracking pressure, as illustrated at the starting point of graph (c). Since the cracking pressure is greater for the 2.0 psi cracking pressure check valve (solid line), the initial condition of the reservoir pressure after operating the tool is lower than that of a 0.25 cracking pressure check valve (dashed line). As stated previously, lower pressure in the reservoir leads to less oil leakage from the system. Additionally, negative pressures of greater magnitude may also cause the lubrication system to slowly unprime, i.e., to pull lubricant backwards through the lines towards the reservoir. By unpriming the lubrication system due to negative pressure, lubricant is drawn away from the output 140 and towards the reservoir 130, thereby further yielding less leakage of lubricant.

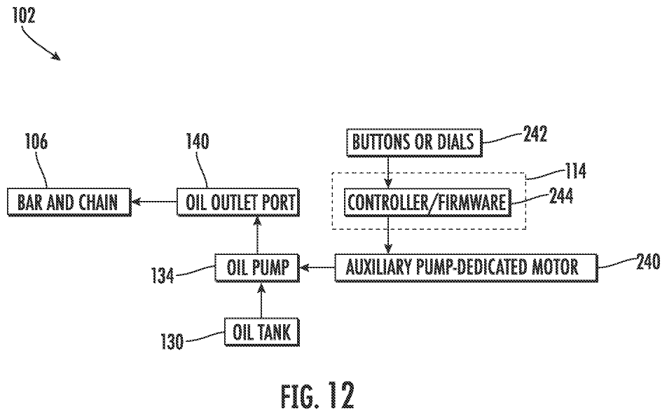

FIG. 12 shows a schematic representation of the operation of the lubrication system 102. The pump 134 may be operated, e.g., controlled and actuated, by the motor assembly 110 or a dedicated pump motor 240. The tool 100 has a control assembly 112 that includes one or more inputs 242 such as buttons or dials to control operation of the tool 100, including but not limited to the trigger 118. The control assembly 112 includes a controller 244, e.g., a printed circuit board (PCB) or other hardware and firmware, which can receive an input from the input(s) 242. The controller 244 is operatively coupled to a motor that can control the pump 134. For instance, a dedicated pump motor 240 may be operatively coupled to the controller 244. The pump motor 240 may be electrically driven by the controller 244 to cause rotation of the pump motor 240. The pump motor 240 may be operatively coupled to a drive gear 246 configured to engage with the pump gear 170. Thus, when the pump motor 240 is driven by the controller 244, the pump 134 is actuated by the pump gear 170 to pump lubricant 132 from the reservoir 130 to the lubricant output 140, thereby delivering lubricant 132 to the bar and chain assembly 106. The present inventors have found that the use of a dedicated pump motor 240 as described above enables improved control of the lubrication system 102 as compared to connecting the pump 134 to the motor assembly 110 of the tool 100.

The lubrication system 102 of the present invention may further include one or more sensors (not shown). The sensor(s) may be configured to detect an operational state of the lubrication system 102 (i.e., on/off or otherwise disabled, deactivated), and/or a flow rate of lubricant 132 through the pump 134. Additionally, a sensor may be provided to detect an amount of lubricant 132 in the reservoir 130, e.g., if the amount of lubricant 132 is below a threshold amount. The sensor(s) may include any suitable type of sensor including but not limited to a rotary encoder and a potentiometer. The sensor(s) may be operatively coupled to the control assembly 112, e.g., the controller 244.

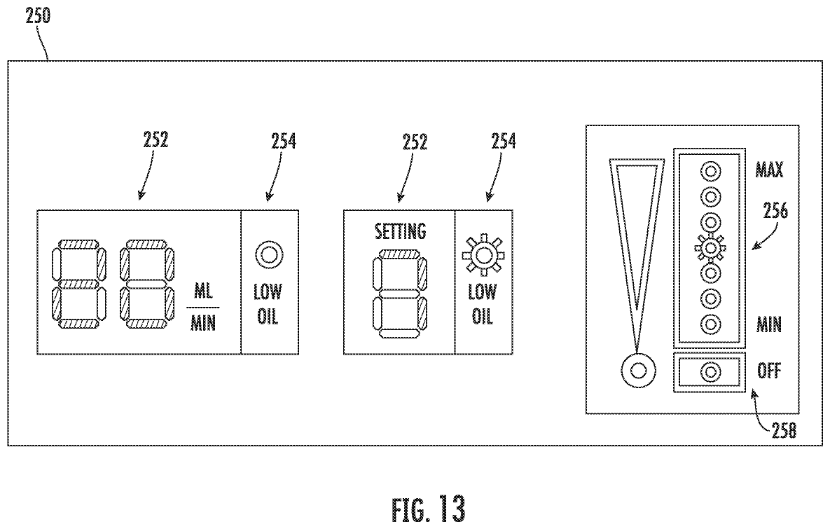

The tool 100 may further include at least one display system 250, e.g., as shown in FIG. 13. The display system 250 may be configured to display aspects of the operation of the lubrication system 102 to a user. For instance, the display system 250 may include a numerical display 252 showing a current flow rate of lubricant including the units of flow and/or a current flow rate of lubricant as a numbered setting (e.g., on a scale of 0 to 5, with 0 being no flow of lubricant and 5 being the highest flow of lubricant). Additionally or alternatively, the display system 250 may include one or more indicator lights. For instance, there may be an indicator light 254 that illuminates when the volume of lubricant 132 in the reservoir 130 decreases below a set threshold. Additionally or alternatively, the display system 250 may include a series of indicator lights 256 representative of settings of the lubrication system 102, e.g., flow rate, in which each light may illuminate when its corresponding setting is selected. An indicator light 258 may further represent if the lubrication system 102 has been turned off, disabled or deactivated. Additionally or alternatively, the display system 250 may display any output from any sensor(s), e.g., rotary encoder, potentiometer, or other sensor coupled with the lubrication system 102.

Further aspects of the invention are provided by one or more of the following embodiments:

A lubrication pump for pumping a lubricant in a power tool, the pump including a housing having an inlet, an outlet and a reservoir extending between the inlet and the outlet, a piston disposed within the housing, the piston comprising a cut-out section at one end configured to be disposed within the reservoir and an inclined surface at an opposite end of the piston relative to the reservoir, a bias spring configured to bias the piston in a first direction, a gear configured to operably couple with a drive gear to drive movement of the piston, and a lubricant flow adjustment system including: an adjuster body configured to contact the inclined surface of the piston, a pin extending from the adjuster body at one end thereof, and a detent spring at an opposite end of the adjuster body from the pin and configured to bias the adjuster body in a second direction, wherein the housing comprises an adjustment section comprising an adjuster housing in which the adjuster body is disposed and plurality of detent pockets disposed at a top surface of the adjuster housing, each detent pocket having a different height, wherein the pin is configured to be exposed from the top of the adjuster housing and seated within one of the detent pockets, further wherein a position of the detent pin is configured to control an amount of reciprocating movement of the piston in the first direction to controllably adjust an amount of lubricant dispensed through the pump over a range of about 17 mL/min.

A pump of any one or more embodiments disclosed herein, wherein the amount of lubricant dispensed through the pump over a range of about 17 mL/min comprises a range from about 3 mL/min to about 20 mL/min.

A pump of any one or more embodiments disclosed herein, wherein the plurality of detent pockets comprises at least four detent pockets.

A pump of any one or more embodiments disclosed herein, wherein the plurality of detent pockets comprises seven detent pockets.

A pump of any one or more embodiments disclosed herein, wherein the adjuster housing comprises a generally cylindrical body, further wherein the plurality of detent pockets are disposed about a circumference of the cylindrical body.

A pump of any one or more embodiments disclosed herein, wherein the plurality of detent pockets are disposed around about 270 degrees of the circumference of the cylindrical body.

A pump of any one or more embodiments disclosed herein, wherein at least a portion of the gear is exposed from the housing.

A pump of any one or more embodiments disclosed herein, wherein the gear extends outside the housing from a longitudinal direction.

A pump of any one or more embodiments disclosed herein, further comprising a grease cap configured to surround the top surface of the adjuster housing.

A lubrication system for a power tool, including a reservoir, a pump, and an anti-leak mechanism, wherein the lubrication system is configured to transport a lubricant from the reservoir to an output configured to supply the lubricant to a tool unit of the power tool, wherein the anti-leak mechanism is a separate component from the pump and the output, and wherein the anti-leak mechanism is disposed upstream of the output.

A lubrication system of any one or more embodiments disclosed herein, wherein the anti-leak mechanism comprises a valve comprising a valve inlet, a valve outlet, a valve body, and a stem, wherein the stem comprises at least one seal disposed about a circumferential surface of the stem, wherein in a closed position of the valve, the stem is configured to extend through the valve body in an arrangement that prevents flow of lubricant from the valve inlet to the valve outlet, and in an open position of the valve, the stem is retracted within the valve body to enable flow of lubricant from the valve inlet to the valve outlet.

A lubrication system of any one or more embodiments disclosed herein, wherein the anti-leak mechanism is actuated by a direct user interface, an indirect user interface, or electronically.

A lubrication system of any one or more embodiments disclosed herein, wherein the anti-leak mechanism is disposed upstream of the pump.

A lubrication system of any one or more embodiments disclosed herein, wherein the anti-leak mechanism is disposed downstream of the pump.

A lubrication system of any one or more embodiments disclosed herein, further comprising a first hose coupling the reservoir to the pump and a second hose coupling the pump to the output, wherein the anti-leak mechanism comprises at least one hose manipulator configured to controllably manipulate flow of a lubricant through the first hose and/or the second hose.

A lubrication system of any one or more embodiments disclosed herein, wherein the hose manipulator comprises a first member and a second member, wherein the first hose and/or the second hose is configured to be bent, squeezed, compressed, kinked, pinched, or folded between the first member and the second member to prevent flow of lubricant therethrough.

A lubrication system of any one or more embodiments discloses herein, the reservoir comprising a check valve having a cracking pressure of at least 1.5 psi, wherein the anti-leak mechanism comprises the check valve.

A tool including a motor assembly, a tool unit powered by the motor assembly, the tool unit comprising a guide bar and a chain circumscribing a portion of the guide bar; and a lubrication system that provides lubricant to the chain, the lubrication system comprising a reservoir housing the lubricant, a pump, an output configured to supply the lubricant to the guide bar and the chain, and a pump motor configured to power the pump.

A tool including a motor assembly, a tool unit powered by the motor assembly, the tool unit comprising a guide bar and a chain circumscribing a portion of the guide bar; a lubrication system that provides lubricant to the chain, the lubrication system comprising a reservoir housing the lubricant, a pump, an output configured to supply the lubricant to the guide bar and the chain; and a display system configured to display one or more operating parameters of the lubrication system.

An apparatus as shown and described in one or more embodiments herein.

A system configured to operate in accordance with any one or more embodiments disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A lubrication pump for pumping a lubricant in a power tool, the pump comprising:
a housing having an inlet, an outlet and a reservoir extending between the inlet and the outlet;
a piston disposed within the housing, the piston comprising a cut-out section at one end configured to be disposed within the reservoir and an inclined surface at an opposite end of the piston relative to the reservoir;
a bias spring configured to bias the piston in a first direction;
a gear configured to operably couple with a drive gear to drive movement of the piston; and
a lubricant flow adjustment system comprising:
an adjuster body configured to contact the inclined surface of the piston;
a pin extending from the adjuster body at one end thereof; and
a detent spring at an opposite end of the adjuster body from the pin and configured to bias the adjuster body in a second direction;
wherein the housing comprises an adjustment section comprising an adjuster housing in which the adjuster body is disposed and plurality of detent pockets disposed at a top surface of the adjuster housing, each detent pocket having a different height, wherein the pin is configured to be exposed from the top of the adjuster housing and seated within one of the detent pockets,
further wherein a position of the detent pin is configured to control an amount of reciprocating movement of the piston in the first direction to controllably adjust an amount of lubricant dispensed through the pump over a range of about 17 mL/min.

2. The pump of claim 1, wherein the amount of lubricant dispensed through the pump over a range of about 17 mL/min comprises a range from about 3 mL/min to about 20 mL/min.

3. The pump of claim 1, wherein the plurality of detent pockets comprises at least four detent pockets.

4. The pump of claim 1, wherein the plurality of detent pockets comprises seven detent pockets.

5. The pump of claim 1, wherein the adjuster housing comprises a generally cylindrical body, further wherein the plurality of detent pockets are disposed about a circumference of the cylindrical body.

6. The pump of claim 5, wherein the plurality of detent pockets are disposed around about 270 degrees of the circumference of the cylindrical body.

7. The pump of claim 1, wherein at least a portion of the gear is exposed from the housing.

8. The pump of claim 7, wherein the gear extends outside the housing from a longitudinal direction.

9. The pump of claim 1, further comprising a grease cap configured to surround the top surface of the adjuster housing.

10. A lubrication system for a power tool, comprising:
a reservoir, a pump, and an anti-leak mechanism;
wherein the lubrication system is configured to transport a lubricant from the reservoir to an output configured to supply the lubricant to a tool unit of the power tool;
wherein the anti-leak mechanism is a separate component from the pump and the output; and
wherein the anti-leak mechanism is disposed upstream of the output.

11. The lubrication system of claim 10, wherein the anti-leak mechanism comprises a shutoff valve comprising a valve inlet, a valve outlet, a valve body, and a stem, wherein the stem comprises at least one seal disposed about a circumferential surface of the stem, wherein in a closed position of the valve, the stem is configured to extend through the valve body in an arrangement that prevents flow of lubricant from the valve inlet to the valve outlet, and in an open position of the valve, the stem is retracted within the valve body to enable flow of lubricant from the valve inlet to the valve outlet.

12. The lubrication system of claim 10, wherein the anti-leak mechanism is actuated by a direct user interface, an indirect user interface, or electronically.

13. The lubrication system of claim 10, wherein the anti-leak mechanism is disposed upstream of the pump.

14. The lubrication system of claim 10, wherein the anti-leak mechanism is disposed downstream of the pump.

15. The lubrication system of claim 10, further comprising a first hose coupling the reservoir to the pump and a second hose coupling the pump to the output,
wherein the anti-leak mechanism comprises at least one hose manipulator configured to controllably manipulate flow of a lubricant through the first hose and/or the second hose.

16. The lubrication system of claim 15, wherein the hose manipulator comprises a first member and a second member, wherein the first hose and/or the second hose is configured to be bent, squeezed, compressed, kinked, pinched, or folded between the first member and the second member to prevent flow of lubricant therethrough.

17. The lubrication system of claim 10, the reservoir comprising a check valve having a cracking pressure of at least 1.5 psi, wherein the anti-leak mechanism comprises the check valve.

18. The lubrication system of claim 10, wherein the pump comprises:
a housing having an inlet, an outlet and a reservoir extending between the inlet and the outlet;
a piston disposed within the housing, the piston comprising a cut-out section at one end configured to be disposed within the reservoir and an inclined surface at an opposite end of the piston relative to the reservoir;
a bias spring configured to bias the piston in a first direction;
a gear configured to operably couple with a drive gear to drive movement of the piston; and
a lubricant flow adjustment system comprising:
an adjuster body configured to contact the inclined surface of the piston;
a pin extending from the adjuster body at one end thereof; and
a detent spring at an opposite end of the adjuster body from the pin and configured to bias the adjuster body in a second direction;
wherein the housing comprises an adjustment section comprising an adjuster housing in which the adjuster body is disposed and plurality of detent pockets disposed at a top surface of the adjuster housing, each detent pocket having a different height, wherein the pin is configured to be exposed from the top of the adjuster housing and seated within one of the detent pockets,
further wherein a position of the detent pin is configured to control an amount of reciprocating movement of the piston in the first direction to controllably adjust an amount of lubricant dispensed through the pump over a range of about 17 mL/min.

19. A tool comprising:
a motor assembly;
a tool unit powered by the motor assembly, the tool unit comprising:
a guide bar and a chain circumscribing a portion of the guide bar; and
a lubrication system that provides lubricant to the chain, the lubrication system comprising:
a reservoir housing the lubricant,
a pump,
an output configured to supply the lubricant to the guide bar and the chain, and
a pump motor configured to power the pump.

20. A tool comprising:
a motor assembly;
a tool unit powered by the motor assembly, the tool unit comprising:
a guide bar and a chain circumscribing a portion of the guide bar;
a lubrication system that provides lubricant to the chain, the lubrication system comprising a reservoir housing the lubricant, a pump, an output configured to supply the lubricant to the guide bar and the chain; and
a display system configured to display one or more operating parameters of the lubrication system.
